(19) United States
(12) Patent Application Publication
(10) Pub. No.: US 2026/0246545 A1
(43) Pub. Date: Aug. 20, 2026

(54) REGRESSION-BASED PASSIVE INTERMODULATION DETECTION METHODS

(71) Applicant: Telefonaktiebolaget LM Ericsson (publ), Stockholm (SE)

(72) Inventors: Minkeun CHUNG, Märsta (SE); Mark WYVILLE, Ottawa (CA); Samr ALI, Saint-Laurent (CA); Yimin NIE, Montreal (CA); Aydin SARRAF, Pierrefonds (CA)

(21) Appl. No.: 19/161,990

(22) PCT Filed: Mar. 8, 2023
(86) PCT No.: PCT/IB2023/052212

§ 371 Date: Sep. 3, 2025

(51) Int. Cl. H04B 17/20; H04B 1/10

(52) U.S. Cl. CPC H04B 17/204; H04B 1/1027

(57) ABSTRACT

A method and network node for regression-based passive intermodulation (PIM) detection methods are disclosed. According to one aspect, a method in a network node configured to communicate with wireless devices (WDs). The method includes, at each time of a plurality of successive times: determining a first difference between a downlink physical resource block (PRB) utilization at a present time and a downlink PRB utilization at a previous time, and determining a second difference between an uplink interference plus noise (IpN) power at the present time and an uplink IpN power at the previous time. The method also includes performing a regression analysis based at least in part on a first sequence of the first differences and a second sequence of the second differences to determine an association between downlink signals and uplink signals influenced by PIM.

### TECHNICAL FIELD

The present disclosure relates to wireless communications, and in particular, to regression-based passive intermodulation (PIM) detection methods.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

This disclosure relates to passive intermodulation (PIM) detection in a cellular network such as a 3GPP communication network. PIM occurs when two or more signals are mixed in a passive non-linear device or element, such as filters, antennas, and connectors. Coupled downlink (DL) signals can cause the PIM. In frequency division duplex (FDD) systems, the PIM generated by the downlink signals causes significant interference to neighboring uplink (UL) bands, resulting in the degradation of UL performance. Mitigation of PIM interference may be preceded by PIM detection.

A recent method adopts radio access network (RAN) performance measurement (PM) counters for identifying PIM products. The concept behind this method is that if a combination of DL sector carriers causes PIM interference to an UL sector carrier, the corresponding DL traffic loads should positively correlate with the corresponding UL interference and noise measure.

But known solutions based on this general observation have at least three limitations. First, the traffic load of each DL sector carrier has a similar pattern over of slowly time-varying natural traffic fluctuations. For example, higher traffic occurs in in daytime and lower traffic occurs at night. This is illustrated in FIG. 1. This slow time variation may interfere with determining an impact on UL interference and noise (IpN) at uplink frequencies caused by PIM generated by transmitting downlink traffic on downlink frequencies. Second, linear regressions for every DL combination, are required. Suppose, for example, that there are K DL sector carriers within a base station site or cluster of sites. The number of the DL sector-carrier pairs and triples, respectively, is KC2 and KC3, which increases on the order of K² (pairs)/K³ (triples). This results in a high computational burden. Third, the existing solutions can detect only the most dominant DL sector carrier or combination, which is a limitation in the presence of multiple DL combinations causing PIM.

### SUMMARY

Some embodiments advantageously provide methods and network nodes for regression-based passive intermodulation (PIM) detection methods.

Some embodiments employ a regression-based PIM-detection method that enables detection of the DL sector carrier(s) causing PIM that interferes with one or more uplink signals. The regression is performed based on PIM data from real networks. The PIM data used in some of the methods disclosed herein includes DL physical resource block (PRB) utilization and UL IpN power. Some embodiments operate based on an assumption that when a DL sector carrier is one of sources causing PIM to a UL sector carrier, the differential of the corresponding DL PRB utilization positively correlates with that of the UL IpN power. By performing regression analysis based on the differentials of DL PRB utilization and UL IpN, the effect on uplink signals of PIM generated by downlink signals may be determined. Based on the regression results, which DL sector carriers are causing degradation to which UL sector carriers may be determined. One or both of two modelling approaches may be employed for the regression, single-regressor (SR) and multiple-regressor (MR) models. There exists a complexity-fidelity tradeoff between the two models. Thus, some embodiments use the differentials of DL PRB utilization/UL IpN power for regression analysis.

In known solutions, raw values of DL PRB utilization and UL IpN power are used for regression. The raw values of each UL or DL sector carrier create a similar pattern over time by cause by natural fluctuations between daytime and nighttime traffic. This creates a multicollinearity problem among different UL/DL sector carriers and may interfere making correct PIM-detection decisions. Embodiments disclosed herein overcome this problem by performing the regression analysis, not based on raw values of DL PRB utilization and UL IpN power, but rather based on the difference between DL PRB utilization at successive times and based on the difference in UL IpN power at the corresponding successive times.

Some embodiments include performance of regression based on a single-regressor model that provides lower complexity than using a multiple-regressor model. However, the multiple-regressor model provides the relative impact of multiple DL carriers, which may result in better PIM detection decisions. Thus, there is a tradeoff between complexity and PIM detection decision quality. Some embodiments, make this tradeoff.

In some embodiments, the differences between DL PRB utilization at each recording time, are relatively independent among sector carriers, as compared to their raw values at each recording time. This property is useful for identifying which DL sector carriers are causing PIM to which UL sector carriers. Complexity may be reduced in some embodiments, by using a lower number of regressions than known methods. This results in less computational time to determine the regressions at or between each recorded time instance so that a higher number of UL/DL sector carrier combinations may be monitored for the PIM detection. Some embodiments detect multiple DL sector carriers causing PIM while known methods only detect the most dominant DL sector carrier or combination.

According to one aspect, a method in a network node configured to communicate with a wireless device (WD) is provided. The method includes, at each time of a plurality of successive times: determining a first difference between a downlink physical resource block, PRB, utilization at a present time and a downlink PRB utilization at a previous time, and determining a second difference between an uplink interference plus noise, IpN, power at the present time and an uplink IpN power at the previous time. The method also includes performing a regression analysis based at least in part on a first sequence of the first differences and a second sequence of the second differences to determine an association between downlink signals and uplink signals influenced by passive intermodulation (PIM).

According to this aspect, in some embodiments, determining an association between the downlink signals and the uplink signals includes determining which downlink frequencies are generating PIM affecting a particular uplink signal. In some embodiments, the regression analysis is a single-regressor analysis. In some embodiments, the single-regressor analysis includes regression analysis of a differential downlink PRB utilization for each of a plurality of UP IpN powers. In some embodiments, the regression analysis is a multiple-regressor analysis. In some embodiments, the multiple-regressor analysis includes regression analysis of a plurality of differential downlink PRB utilizations for each of a plurality of UP IpN powers. In some embodiments, a time duration between two successive times of the successive times is selected to compensate for a background correlation between downlink PRB utilization and UL IpN power. In some embodiments, a time duration between two successive times of the successive times is selected to compensate for a background correlation between downlink PRB utilizations on different downlink carrier frequencies. In some embodiments, the UL IpN power is an average UL IpN. In some embodiments, the DL PRB utilization is an average DL PRB utilization. In some embodiments, performing the regression analysis includes performing at least one metric determination, the at least one metric determination including a determination of at least one of a slope, an intercept and a fitting metric for the regression analysis. In some embodiments, further comprising, for each downlink carrier frequency of a set of downlink carrier frequencies, determining a correlation between downlink PRB utilization on the downlink carrier frequency and uplink IpN power on an uplink carrier frequency, a magnitude of the correlation being indicative of an extent of passive intermodulation at the uplink carrier frequency generated by a signal transmitted at the downlink carrier frequency. In some embodiments, further comprising determining a correlation between downlink PRB utilizations on different downlink carrier frequencies, a magnitude of the correlation being indicative of an extent of passive intermodulation at the uplink carrier frequency generated by a signal transmitted at each downlink carrier frequency. In some embodiments, further comprising ordering downlink carrier frequencies of the set of downlink carrier frequencies according to an extent of passive intermodulation of an uplink signal at the uplink carrier frequency as indicated by the determined correlation.

According to another aspect, a network node configured to communicate with a wireless device (WD) is provided. The network node includes processing circuitry configured to, at each time of a plurality of successive times: determine a first difference between a downlink physical resource block, PRB, utilization at a present time and a downlink PRB utilization at a previous time, and determine a second difference between an uplink interference plus noise, IpN, power at the present time and an uplink IpN power at the previous time. The processing circuitry is further configured to perform a regression analysis based at least in part on a first sequence of the first differences and a second sequence of the second differences to determine an association between downlink signals and uplink signals influenced by passive intermodulation (PIM).

According to this aspect, in some embodiments, determining an association between the downlink signals and the uplink signals includes determining which downlink frequencies are generating PIM affecting a particular uplink signal. In some embodiments, the regression analysis is a single-regressor analysis. In some embodiments, the single-regressor analysis includes regression analysis of a differential downlink PRB utilization for each of a plurality of UP IpN powers. In some embodiments, the regression analysis is a multiple-regressor analysis. In some embodiments, the multiple-regressor analysis includes regression analysis of a plurality of differential downlink PRB utilizations for each of a plurality of UP IpN powers. In some embodiments, a time duration between two successive times of the successive times is selected to compensate for a background correlation between downlink PRB utilization and UL IpN power. In some embodiments, a time duration between two successive times of the successive times is selected to compensate for a background correlation between downlink PRB utilizations on different downlink carrier frequencies. In some embodiments, the UL IpN power is an average UL IpN. In some embodiments, the DL PRB utilization is an average DL PRB utilization. In some embodiments, performing the regression analysis includes performing at least one metric determination, the at least one metric determination including a determination of at least one of a slope, an intercept and a fitting metric for the regression analysis. In some embodiments, the processing circuitry is further configured to, for each downlink carrier frequency of a set of downlink carrier frequencies, determine a correlation between downlink PRB utilization on the downlink carrier frequency and uplink IpN power on an uplink carrier frequency, a magnitude of the correlation being indicative of an extent of passive intermodulation at the uplink carrier frequency generated by a signal transmitted at the downlink carrier frequency. In some embodiments, the processing circuitry is further configured to determine a correlation between downlink PRB utilizations on different downlink carrier frequencies, a magnitude of the correlation being indicative of an extent of passive intermodulation at the uplink carrier frequency generated by a signal transmitted at each downlink carrier frequency. In some embodiments, the processing circuitry is further configured to order downlink carrier frequencies of the set of downlink carrier frequencies according to an extent of passive intermodulation of an uplink signal at the uplink carrier frequency as indicated by the determined correlation.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates time-varying PIM over a daytime-nighttime cycle;

FIG. 2 is a schematic diagram of an example network architecture illustrating a communication system connected via an intermediate network to a host computer according to the principles in the present disclosure;

FIG. 3 is a block diagram of a host computer communicating via a network node with a wireless device over an at least partially wireless connection according to some embodiments of the present disclosure;

FIG. 4 is a flowchart illustrating example methods implemented in a communication system including a host computer, a network node and a wireless device for executing a client application at a wireless device according to some embodiments of the present disclosure;

FIG. 5 is a flowchart illustrating example methods implemented in a communication system including a host computer, a network node and a wireless device for receiving user data at a wireless device according to some embodiments of the present disclosure;

FIG. 6 is a flowchart illustrating example methods implemented in a communication system including a host computer, a network node and a wireless device for receiving user data from the wireless device at a host computer according to some embodiments of the present disclosure;

FIG. 7 is a flowchart illustrating example methods implemented in a communication system including a host computer, a network node and a wireless device for receiving user data at a host computer according to some embodiments of the present disclosure;

FIG. 8 is a flowchart of an example process in a network node for regression-based passive intermodulation (PIM) detection methods;

FIG. 9 is a block diagram showing a PIM detection unit configured to identify DL carriers contributing to PIM interference with DL carriers in three different sectors; and

FIG. 10 is a flowchart of an example process for PIM detection and classification according to principles disclosed herein.

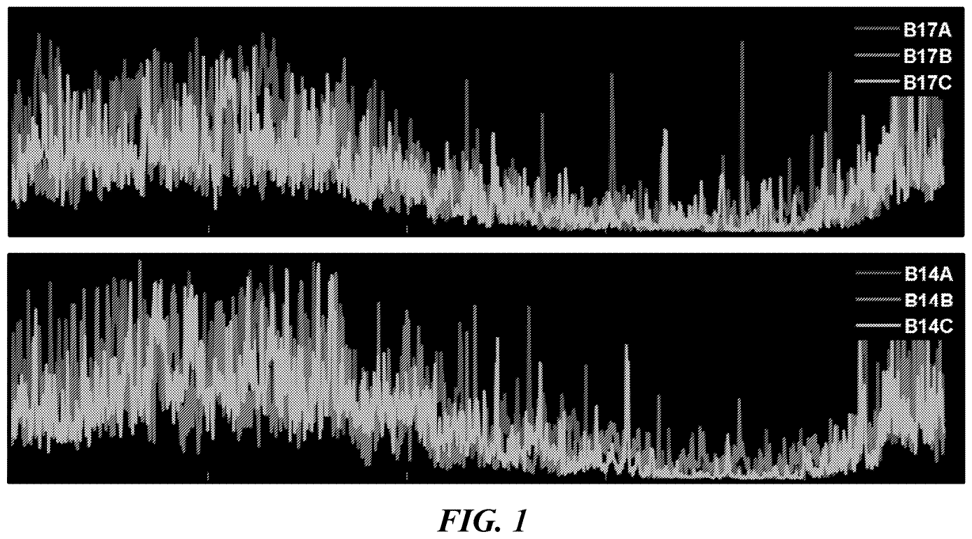

### DETAILED DESCRIPTION

Before describing in detail example embodiments, it is noted that the embodiments reside primarily in combinations of apparatus components and processing steps related to regression-based passive intermodulation (PIM) detection methods. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

The term background correlation may refer to a correlation between downlink PRB utilizations on different downlink carrier frequencies that varies according to a time variation that occurs naturally as a result of greater usage of the cellular system during the day as compared to night. The term background correlation may also, or alternatively, refer to a correlation between downlink PRB utilization and UL IpN power that varies due to the time variation that occurs naturally as a result of the greater usage of the cellular system during the day as compared to night.

Note further that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide regression-based passive intermodulation (PIM) detection methods.

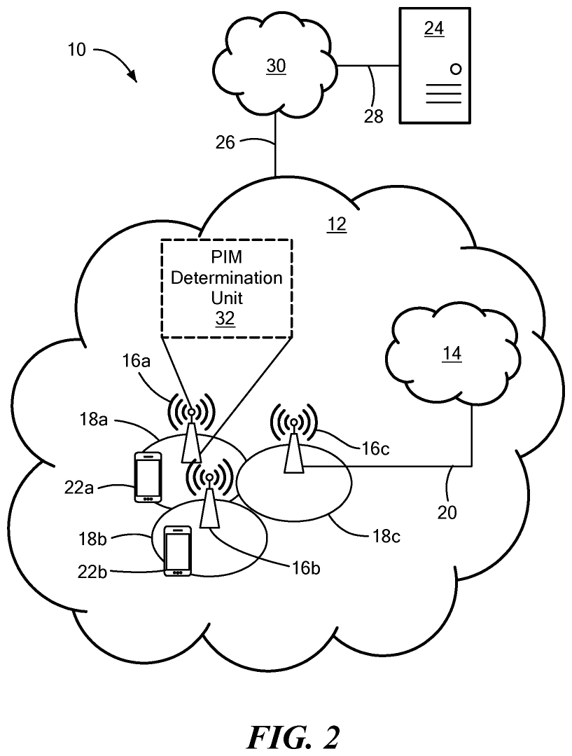

Returning now to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 2 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a PIM determination unit 32 which is configured to perform a regression analysis based at least in part on a first sequence of the first differences and a second sequence of the second differences to determine an association between downlink signals and uplink signals influenced by passive intermodulation (PIM).

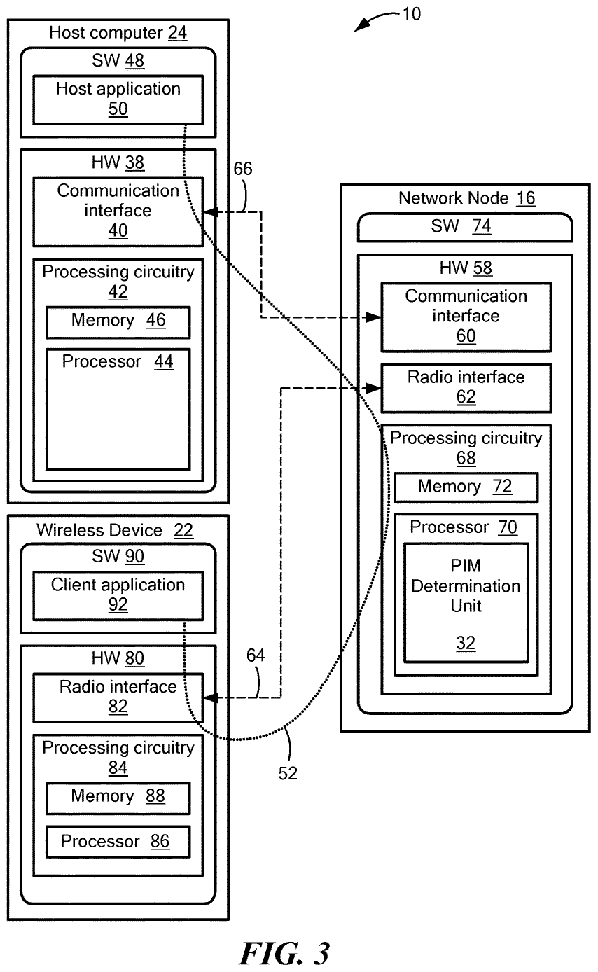

Example implementations, in accordance with an embodiment, of the WD 22, network node 16 and host computer 24 discussed in the preceding paragraphs will now be described with reference to FIG. 3. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a PIM determination unit 32 which is configured to perform a regression analysis based at least in part on a first sequence of the first differences and a second sequence of the second differences to determine an association between downlink signals and uplink signals influenced by passive intermodulation (PIM).

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22.

In some embodiments, the inner workings of the network node 16, WD 22, and host computer 24 may be as shown in FIG. 3 and independently, the surrounding network topology may be that of FIG. 2.

In FIG. 3, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 2 and 3 show various “units” such as PIM determination unit 32 as being within a respective processor, it is contemplated that these units may be implemented such that a portion of the unit is stored in a corresponding memory within the processing circuitry. In other words, the units may be implemented in hardware or in a combination of hardware and software within the processing circuitry.

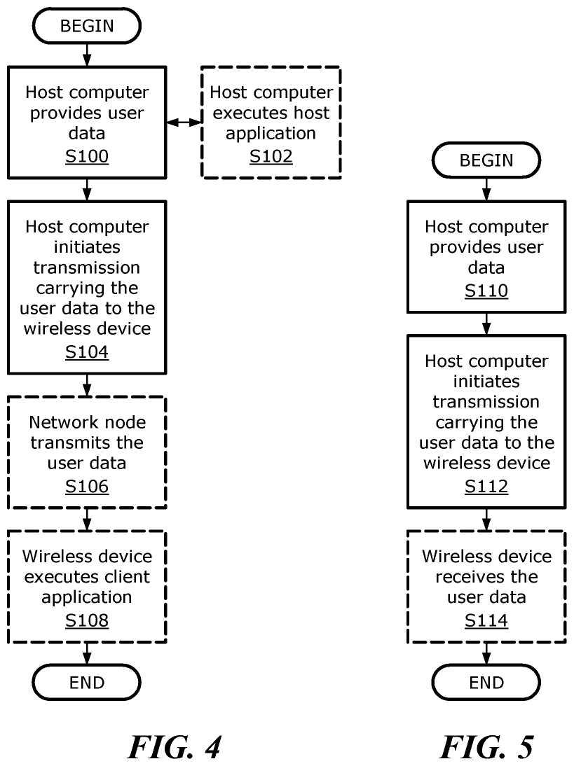

FIG. 4 is a flowchart illustrating an example method implemented in a communication system, such as, for example, the communication system of FIGS. 2 and 3, in accordance with one embodiment. The communication system may include a host computer 24, a network node 16 and a WD 22, which may be those described with reference to FIG. 3. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 5 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

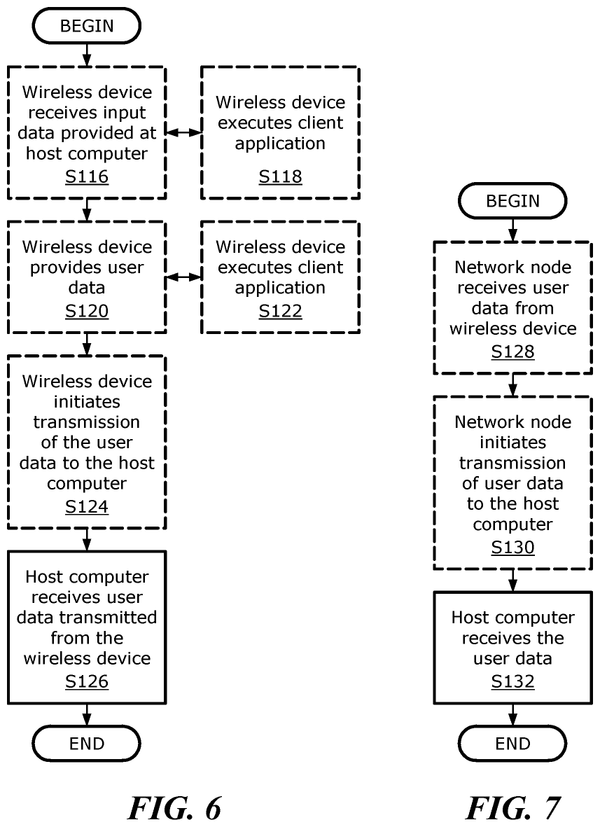

FIG. 6 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 7 is a flowchart illustrating an example method implemented in a communication system, such as, for example, the communication system of FIG. 2, in accordance with one embodiment. The communication system may include a host computer 24, a network node 16 and a WD 22, which may be those described with reference to FIGS. 2 and 3. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

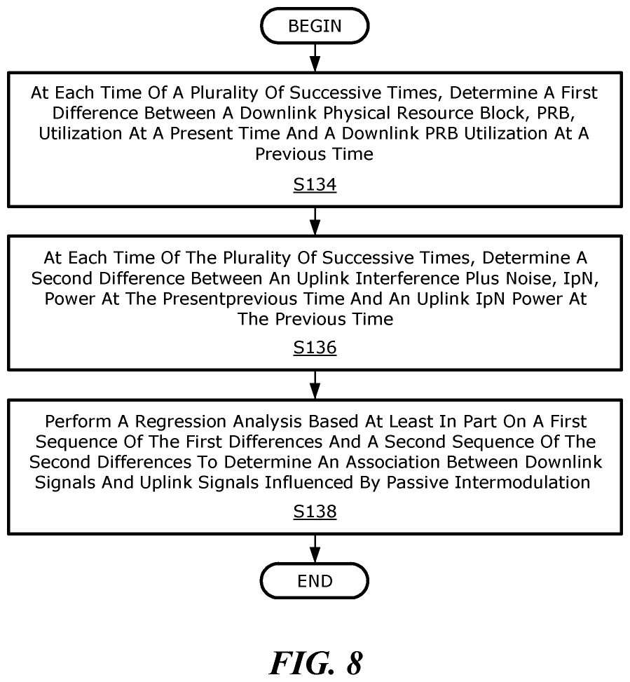

FIG. 8 is a flowchart of an example process in a network node 16 for regression-based passive intermodulation (PIM) detection methods. One or more blocks described herein may be performed by one or more elements of network node 16 such as by one or more of processing circuitry 68 (including the PIM determination unit 32), processor 70, radio interface 62 and/or communication interface 60. Network node 16 such as via processing circuitry 68 and/or processor 70 and/or radio interface 62 and/or communication interface 60 is configured to, at each time of a plurality of successive times: determining a first difference between a downlink physical resource block, PRB, utilization at a present time and a downlink PRB utilization at a previous time (Block S134), and determining a second difference between an uplink interference plus noise, IpN, power at the present time and an uplink IpN power at the previous time (Block S136). The method also includes performing a regression analysis based at least in part on a first sequence of the first differences and a second sequence of the second differences to determine an association between downlink signals and uplink signals influenced by passive intermodulation (PIM) (Block S138).

According to this aspect, in some embodiments, determining an association between the downlink signals and the uplink signals includes determining which downlink frequencies are generating PIM affecting a particular uplink signal. In some embodiments, the regression analysis is a single-regressor analysis. In some embodiments, the single-regressor analysis includes regression analysis of a differential downlink PRB utilization for each of a plurality of UP IpN powers. In some embodiments, the regression analysis is a multiple-regressor analysis. In some embodiments, the multiple-regressor analysis includes regression analysis of a plurality of differential downlink PRB utilizations for each of a plurality of UP IpN powers. In some embodiments, a time duration between two successive times of the successive times is selected to compensate for a background correlation between downlink PRB utilization and UL IpN power. In some embodiments, a time duration between two successive times of the successive times is selected to compensate for a background correlation between downlink PRB utilizations on different downlink carrier frequencies. In some embodiments, the UL IpN power is an average UL IpN. In some embodiments, the DL PRB utilization is an average DL PRB utilization. In some embodiments, performing the regression analysis includes performing at least one metric determination, the at least one metric determination including a determination of at least one of a slope, an intercept and a fitting metric for the regression analysis. In some embodiments, further comprising, for each downlink carrier frequency of a set of downlink carrier frequencies, determining a correlation between downlink PRB utilization on the downlink carrier frequency and uplink IpN power on an uplink carrier frequency, a magnitude of the correlation being indicative of an extent of passive intermodulation at the uplink carrier frequency generated by a signal transmitted at the downlink carrier frequency. In some embodiments, further comprising determining a correlation between downlink PRB utilizations on different downlink carrier frequencies, a magnitude of the correlation being indicative of an extent of passive intermodulation at the uplink carrier frequency generated by a signal transmitted at each downlink carrier frequency. In some embodiments, further comprising ordering downlink carrier frequencies of the set of downlink carrier frequencies according to an extent of passive intermodulation of an uplink signal at the uplink carrier frequency as indicated by the determined correlation.

Having described the general process flow of arrangements of the disclosure and having provided examples of hardware and software arrangements for implementing the processes and functions of the disclosure, the sections below provide details and examples of arrangements for regression-based passive intermodulation (PIM) detection methods.

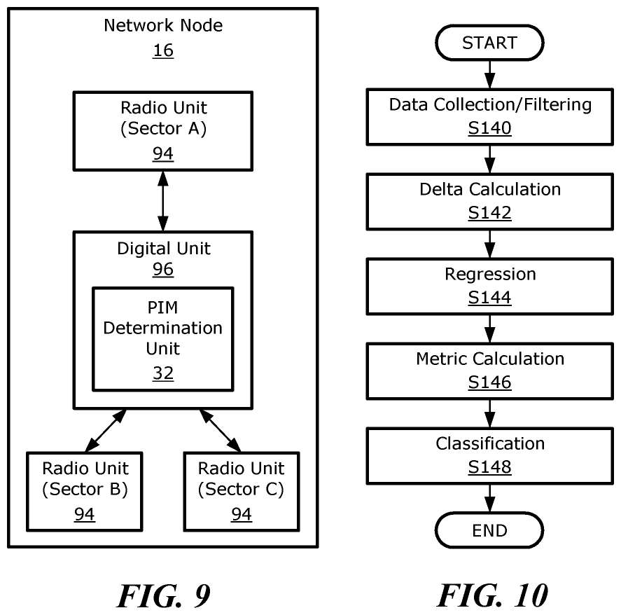

Embodiments disclosed herein are applicable to an FDD system, which allows UL and DL transmission at the same time, but over different frequency bands. FIG. 9 illustrates three radio units 94 in communication with a digital unit 96 that supports K sector carriers in total. The radio units 94 may be implemented in a network node 16 by multiple radio interfaces 62 having antennas configured to radiate in different sectors. The digital unit 96 may be implemented by the processing circuitry 68.

Each radio unit 94 may cover different sectors A, B, and C. The UL/DL bands of sector carriers involved in each radio unit may be different among the sectors or identical to each other. Apparatus for PIM-detection is placed in the digital unit 96 which includes the PIM determination unit 32. The PIM data is collected from all the radio units, i.e., all the sectors, and is made available in the digital unit 96 PIM detection by the PIM determination unit 32. The DL sector carriers causing PIM are referred to herein as aggressors and the UL sector carriers interfered by PIM are referred to herein as victims.

An example of an aggressor/victim sector-carrier set with K=9, respectively, may be represented by

$$𝒜 = \{ 17 A , 17 B , 17 C , 14 A , 14 B , 14 C , 30 A , 30 B , 30 C \} ,$$

$$𝒱 = \{ 17 A , 17 B , 17 C , 14 A , 14 B , 14 C , 30 A , 30 B , 30 C \}$$

where the element in each set consists of a number and an letter which indicate a frequency-band index and a sector index, respectively. For example, 17A denotes the sector carrier for Band17 of the sectorA.

FIG. 10 is a flowchart of an example PIM-detection method. For each recording index nϵ{1, 2, . . . , N}, average DL PRB utilization of the aggressor cell aϵ [symbol] and average UL IpN power of the victim cell v E V are collected in the digital unit 96 (Block S140). The DL PRB of the aggressor cell is denoted by xₐ(n) and and the average UL IpN power of the victim cell is denoted by yᵥ(n). Based on the collected data, the differential of each is calculated as follows (Block S142):

$$Δ {x}_{a} ( n ) = {x}_{a} ( n ) - {x}_{a} ( n - 1 ) , n \geq 2$$

$$Δ {y}_{v} ( n ) = {y}_{v} ( n ) - {y}_{v} ( n - 1 ) , n \geq 2$$

One or both of two models, i.e., single-regressor (SR) model and multi-regressor models, may be used for the regression between

$${\{ Δ {x}_{a} ( n ) \}}_{n = 2}^{N} and {\{ Δ {y}_{v} ( n ) \}}_{n = 2}^{N} ( Block S 144 ) .$$

Suppose that a linear regression is applied. Given the victim cell vϵV, the models may be represented as follows:

### SR Model:

$$\{ \begin{matrix}Δ {y}_{v} = {β}_{0 , 17 A} + {β}_{1 , 17 A} Δ {x}_{17 A} \\ Δ {y}_{v} = {β}_{0 , 17 B} + {β}_{1 , 17 B} Δ {x}_{17 B} \\ ⋮ \\ Δ {y}_{v} = {β}_{0 , 30 C} + {β}_{1 , 30 C} Δ {x}_{30 C}\end{matrix}$$

$$MR model :$$

$$Δ {y}_{v} = {β}_{0} + {β}_{1 , 17 A} Δ {x}_{17 A} + {β}_{1 , 17 B} Δ {x}_{17 B} + … + {β}_{1 , 30 C} Δ {x}_{30 C} = {β}_{0} + {\sum }_{a ∈ 𝒜} {β}_{1 , a} Δ {x}_{a}$$

where it is assumed that the aggressor set [symbol] ={17A, 17B, 17C, 14A, 14B, 14C, 30A, 30B, 30C}, β_{0,α} is the intercept for the aggressor cell aϵ [symbol] in the SR model, β₀ the intercept in the MR model, and β_{1,α} the slope for aϵ [symbol] in the SR and MR models. The SR approach has | [symbol] | equations for modelling Δyᵥ, vϵ [symbol] with individual Δxₐ while the MR method has one equation including all the regressors Δxₐ, aϵ [symbol] . The regression is followed by the metric calculation (Block S146), such as slope, intercept, and fitting metric. Based on the metrics, the highly-correlated cells may be classified as aggressor cells (Block S148).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| | |
|---|---|
| DL | Downlink |
| FDD | Frequency Division Duplex |
| IpN | Interference and Noise |
| MR | Multiple-regressor |
| PRB | Physical Resource Block |
| PIM | Passive Intermodulation |
| PM | Performance Measurement |
| RAN | Radio Access Network |
| SR | Single-regressor |
| UL | Uplink |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method in a network node configured to communicate with a wireless device, WD, the method comprising:
at each time of a plurality of successive times:
determining a first difference between a downlink physical resource block, PRB, utilization at a present time and a downlink PRB utilization at a previous time; and
determining a second difference between an uplink interference plus noise, IpN, power at the present time and an uplink IpN power at the previous time; and
performing a regression analysis based at least in part on a first sequence of the first differences and a second sequence of the second differences to determine an association between downlink signals and uplink signals influenced by passive intermodulation (PIM).

2. The method of claim 1, wherein determining an association between the downlink signals and the uplink signals includes determining which downlink frequencies are generating PIM affecting a particular uplink signal.

3. The method of claim 1, wherein the regression analysis is a single-regressor analysis, the single-regressor analysis including regression analysis of a differential downlink PRB utilization for each of a plurality of UP IpN powers.

4. (canceled)

5. The method of claim 1, wherein the regression analysis is a multiple-regressor analysis, the multiple-regressor analysis including regression analysis of a plurality of differential downlink PRB utilizations for each of a plurality of U6P IpN powers.

6. (canceled)

7. The method of claim 1, wherein a time duration between two successive times of the successive times is selected to compensate for a background correlation between downlink PRB utilization and UL IpN power, and to compensate for a background correlation between downlink PRB utilizations on different downlink carrier frequencies.

8. (canceled)

9. The method of claim 1, wherein the UL IpN power is an average UL IpN, and wherein the DL PRB utilization is an average DL PRB utilization.

10. (canceled)

11. The method of claim 1, wherein performing the regression analysis includes performing at least one metric determination, the at least one metric determination including a determination of at least one of a slope, an intercept and a fitting metric for the regression analysis.

12. The method of claim 1, further comprising, for each downlink carrier frequency of a set of downlink carrier frequencies, determining a correlation between downlink PRB utilization on the downlink carrier frequency and uplink IpN power on an uplink carrier frequency, a magnitude of the correlation being indicative of an extent of passive intermodulation at the uplink carrier frequency generated by a signal transmitted at the downlink carrier frequency.

13. The method of claim 1, further comprising determining a correlation between downlink PRB utilizations on different downlink carrier frequencies, a magnitude of the correlation being indicative of an extent of passive intermodulation at the uplink carrier frequency generated by a signal transmitted at each downlink carrier frequency.

14. The method of claim 13, further comprising ordering downlink carrier frequencies of the set of downlink carrier frequencies according to an extent of passive intermodulation of an uplink signal at the uplink carrier frequency as indicated by the determined correlation.

15. A network node configured to communicate with a wireless device, WD, the network node comprising processing circuitry configured to:
at each time of a plurality of successive times:
determine a first difference between a downlink physical resource block, PRB, utilization at a present time and a downlink PRB utilization at a previous time; and
determine a second difference between an uplink interference plus noise, IpN, power at the present time and an uplink IpN power at the previous time; and
perform a regression analysis based at least in part on a first sequence of the first differences and a second sequence of the second differences to determine an association between downlink signals and uplink signals influenced by passive intermodulation.

16. The network node of claim 15, wherein determining an association between the downlink signals and the uplink signals includes determining which downlink frequencies are generating PIM affecting a particular uplink signal.

17. The network node of claim 15, wherein the regression analysis is a single-regressor analysis, the single-regressor analysis including regression analysis of a differential downlink PRB utilization for each of a plurality of UP IpN powers.

18. (canceled)

19. The network node of claim 15, wherein the regression analysis is a multiple-regressor analysis, the multiple-regressor analysis including regression analysis of a plurality of differential downlink PRB utilizations for each of a plurality of UP IpN powers.

20. (canceled)

21. The network node of claim 15, wherein a time duration between two successive times of the successive times is selected to compensate for a background correlation between downlink PRB utilization and UL IpN power and to compensate for a background correlation between downlink PRB utilizations on different downlink carrier frequencies.

22. (canceled)

23. The network node of claim 15, wherein the UL IpN power is an average UL IpN, and wherein the DL PRB utilization is an average DL PRB utilization.

24. (canceled)

25. The network node of claim 15, wherein performing the regression analysis includes performing at least one metric determination, the at least one metric determination including a determination of at least one of a slope, an intercept and a fitting metric for the regression analysis.

26. The network node of claim 15, wherein the processing circuitry is further configured to, for each downlink carrier frequency of a set of downlink carrier frequencies, determine a correlation between downlink PRB utilization on the downlink carrier frequency and uplink IpN power on an uplink carrier frequency, a magnitude of the correlation being indicative of an extent of passive intermodulation at the uplink carrier frequency generated by a signal transmitted at the downlink carrier frequency.

27. The network node of claim 15, wherein the processing circuitry is further configured to determine a correlation between downlink PRB utilizations on different downlink carrier frequencies, a magnitude of the correlation being indicative of an extent of passive intermodulation at the uplink carrier frequency generated by a signal transmitted at each downlink carrier frequency.

28. The network node of claim 27, wherein the processing circuitry is further configured to order downlink carrier frequencies of the set of downlink carrier frequencies according to an extent of passive intermodulation of an uplink signal at the uplink carrier frequency as indicated by the determined correlation.
